(19) United States
(12) Patent Application Publication
(10) Pub. No.: US 2026/0274728 A1
(43) Pub. Date: Sep. 17, 2026

(54) SYNERGISTIC INTEGRATED METHODS FOR PROCESSING HYDROCARBON/ORGANIC MATTER CONTAINING WATER STREAMS

(71) Applicant: Lynas Rare Earths Limited, Perth (AU)

(72) Inventor: Hacib Ben Aissa, Kuala Lumpur (MY)

(21) Appl. No.: 19/566,781

(22) Filed: Mar. 13, 2026

Related U.S. Application Data
(60) Provisional application No. 63/771,733, filed on Mar. 14, 2025.

(51) Int. Cl. C02F 9/00; C02F 1/00; C02F 1/24; C02F 1/44; C02F 1/52; C02F 1/78; C02F 11/06; C02F 11/121; C02F 11/14; C02F 101/10; C02F 101/32

(52) U.S. Cl. CPC C02F 9/00; C02F 1/001; C02F 1/24; C02F 1/441; C02F 1/5236; C02F 1/78; C02F 11/06; C02F 11/121; C02F 11/14; C02F 2101/10; C02F 2101/32; C02F 2201/782; C02F 2303/10

(57) ABSTRACT

A process of valorizing hydrocarbon- and/or organic matter-containing water streams by integrating oil-water separation technology that utilizes microbubbles and nanobubbles with supercritical water gasification technology. The integration of these synergistic technologies may be used to generate several streams of value from the hydrocarbon/organic matter containing water streams.

### CROSS-REFERENCE TO RELATED APPLICATION(S)

This application claims priority to U.S. Provisional Patent Application No. 63/771,733, filed on Mar. 14, 2025, the entire contents of which are incorporated herein by reference.

### TECHNICAL FIELD

The present disclosure relates to systems and methods for valorizing hydrocarbon/organic matter containing water streams (e.g., diluted sludge) by integrating hydrocarbon/organic matter-water separation technology, which utilizes microbubble generation and nanobubble generation equipment to produce a concentrated sludge and chemical oxygen demand (COD) water on the upstream process, and supercritical or subcritical water gasification technology on the downstream process end.

### INTRODUCTION

Generation of hydrocarbon/organic matter and salts/metals containing water streams are steadily increasing due to economic growth, the rapid rise in the world population, and other human activities. Examples of such hydrocarbon/organic matter salt and metals containing water streams, or diluted sludges, include livestock manure, garden yard waste, food waste, sewage sludge (both industrial and municipal), agricultural waste (e.g., palm oil and rubber), waste from oil and gas activities, as well as others.

### SUMMARY

In some aspects, the techniques described herein relate to a system for processing hydrocarbon and/or organic matter containing water streams, the system including: a microbubble generation unit in fluid communication with a diluted sludge source, the diluted sludge source including hydrocarbon and/or organic matter; a microbubble reaction and separation unit in fluid communication with the microbubble generation unit; an ozone generation unit; a nanobubble generation unit in fluid communication with the ozone generation unit; a nanobubble reaction and separation unit in fluid communication with the nanobubble generation unit; a heat exchange unit in fluid communication with the microbubble reaction and separation unit; a sludge dilution unit in fluid communication with the heat exchange unit; a salt separation unit in fluid communication with the sludge dilution unit; a gasification unit in fluid communication with the salt separation unit; and a nitrogen recovery unit in fluid communication with the gasification unit.

In some aspects, the techniques described herein relate to a method for processing a hydrocarbon- and/or organic-matter-containing water stream, the method including: introducing a diluted sludge including hydrocarbon and/or organic matter into a microbubble generation unit; generating microbubbles and contacting the diluted sludge with the microbubbles in a microbubble reaction and separation unit; separating, in the microbubble reaction and separation unit, the diluted sludge into a separated water stream and a concentrated sludge stream; providing a portion of the separated water stream to a heat-exchange unit; adjusting the concentrated sludge by combining the concentrated sludge stream with at least a portion of the separated water stream to form a water-adjusted concentrated sludge; separating salts and inorganic material from the water-adjusted concentrated sludge to form an enhanced treated feedstock; gasifying the enhanced treated feedstock in a gasification unit; recovering nitrogen from products of the gasification unit; directing at least a portion of the separated water stream to a nanobubble generation unit; generating ozone and providing the ozone into a nanobubble generation unit; generating nanobubbles and contacting the separated water stream with the nanobubbles in a nanobubble reaction and separation unit; and producing treated water having reduced chemical oxygen demand, salt content, and mineral content relative to the separated water stream.

### BRIEF DESCRIPTION OF THE DRAWINGS

FIG. 1A and FIG. 1B show a schematic depiction of an integrated system including microbubble separation, nanobubble water treatment including ozone generation, and gasification under supercritical hydrothermal conditions.

FIG. 2 shows experimental example results of the amount of energy produced from raw POME via the hydrothermal gasification process under supercritical conditions.

### DETAILED DESCRIPTION

Materials, methods, and systems disclosed and contemplated herein relate to processes incorporating microbubble separation, nanobubble water treatment, and supercritical hydrothermal gasification (SCHG). Exemplary methods and systems may enable the production and recovery of more energy, clean water, and valuable salt, metals, and minerals from various sources, and at a lower cost per MWh generated, with minimum waste generation per unit volume/mass of initial diluted sludge processed. Exemplary methods and systems can process hydrocarbon/organic matter containing water streams (or dilute sludge) feedstocks into gas and other streams of value from various industries, such as, but not limited to: palm oil mill effluent (POME); POME mixed with decanter cake and/or digestates from palm oil mill processes; or natural rubber field concentrate or skim latex. These streams generate biogas or bio-CO₂ (when the feedstock is organic) and other value streams, like fertilizers and clean water, in a more energy and cost efficient way and with a higher degree of circularity, compared to alternative technologies like anaerobic digestion. Other target streams are those generated by oil and gas/petrochemical, food, and beverage, pharmaceutical, industries, in addition to agricultural and domestic wastes.

Currently, the producers of these hydrocarbon/organic matter and salts/metals containing water effluents or diluted sludges pay for treatment or disposal of these streams during which their intrinsic value, such as energy content and useful products, are lost.

Alternatively, these streams may be used to promote the circular economy by producing energy carriers (such as biogas when the waste is organic), fertilizers, or other products of value; but also, to produce clean water that can be recycled or discharged directly into the environment. Furthermore, these hydrocarbon/organic matter containing water streams (or diluted sludges) often contain salts, minerals, and metals; these contents can also be recovered and recycled.

Microbubble technology is a practical option for the treatment of hydrocarbon/organic matter rich water streams. Microbubbles can be generated by several cavitation methods, such as hydrodynamic, acoustic, particle, electrolysis, and optical. Hydrodynamic and acoustic cavitation have been most widely used in wastewater treatment.

Microbubbles include three portions: an inner gas phase, a gas-liquid interface phase, and an outer liquid phase. Each bubble has a critical radius that is defined by the Young-Laplace equation (Nair et al., 2022; Water Sci Technol (2022) 86 (9): 2138-2156). Microbubbles that have a radius that is smaller than the critical radius generate enormous pressure variations across the gas-liquid interface. These microbubbles also have low buoyancy forces, have a relatively slow rise velocity, and collapse underneath the liquid surface, creating free radicals. The small radius of the microbubbles creates a substantial zeta-potential difference at the gas-liquid interface phase, which tends to attract hydrocarbon/organic matter from the outer liquid phase. The surface adhesion of the hydrocarbon/organic matter to the microbubbles may be enhanced by surface-active additives (e.g., nanoenzymes) (Loo and Chan, 2020; WO 2020/159351 A1).

As the microbubble rises, the separation of suspended hydrocarbon/organic matter from bulk water is accomplished by standard methods (e.g., skimming, clarification), in effect, concentrating the hydrocarbon/organic matter as a froth, flocculates, or concentrated sludge. In existing systems, the concentrated hydrocarbon/organic matter rich sludge may then be disposed of or incinerated (potentially generating energy). Depending on its composition, the resulting concentrated sludge may be further processed or separated, using known means, into other valuable streams, to recover and/or recycle all or part of these various streams for other purposes. In one instance, separated water, which is essentially freed from its hydrocarbon/organic matter, salts, and metals, may be eligible for disposal if the quality of the generated water meets the discharge regulations. In another instance, separated water may be recycled for various purposes within the process or further processed in a nanobubble unit to produce low COD treated water, which meets discharge regulations.

### I. Definitions

Unless otherwise defined, all technical and scientific terms used herein have the same meaning as commonly understood by one of ordinary skill in the art. In case of conflict, the present document, including definitions, will control. Methods and materials are described below, although methods and materials similar or equivalent to those described herein can be used in practice or testing of the present disclosure. All publications, patent applications, patents, and other references mentioned herein are incorporated by reference in their entirety. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “an,” and “the” include plural references unless the context clearly dictates otherwise. The present disclosure also contemplates other embodiments “comprising,” “consisting of,” and “consisting essentially of,” the embodiments or elements presented herein, whether explicitly set forth or not.

The modifiers “about” or “approximately” used in connection with a quantity are inclusive of the stated value and have the meaning dictated by the context (for example, it includes at least the degree of error associated with the measurement of the quantity). These modifiers should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example, “about 1” may also mean from 0.5 to 1.4.

For the recitation of numeric ranges herein, each intervening number therebetween with the same degree of precision is contemplated. For example, for the range of 6-9, the numbers 7 and 8 are contemplated in addition to 6 and 9, and for the range 6.0-7.0, the numbers 6.0, 6.1, 6.2, 6.3, 6.4, 6.5, 6.6, 6.7, 6.8, 6.9, and 7.0 are contemplated. For another example, when a pressure range is described as being between ambient pressure and another pressure, a pressure that is ambient pressure is expressly contemplated.

Definitions of specific functional groups and chemical terms are described in more detail below. For purposes of this disclosure, the chemical elements are identified in accordance with the Periodic Table of the Elements, CAS version, Handbook of Chemistry and Physics, 104th Ed., inside cover, and specific functional groups are defined as described therein.

### II. Exemplary Materials and Substances

Exemplary methods, systems, and techniques use and generate various materials and substances. Example materials include energy carriers, sludges and effluents, rare earth element (REE) solutions, additives, output streams, and other enzymatic materials.

### A. Exemplary Energy Carriers

“Energy carrier” is a substance or phenomenon that stores energy and can convert it into other forms, such as heat, mechanical work, or electricity. Energy carriers can be used for a variety of applications, including power generation, heat, and energy storage. Some examples of energy carriers are methane, hydrogen, natural gas, and energy-rich gas, as well as others.

### B. Exemplary Sludges and Effluents

“Liquid effluent” is a liquid waste that is released into the environment from various sources, such as industrial plants, sewage treatment plants, and agricultural operations, including palm oil mills. Liquid effluent can be partially or completely treated, and can contain a wide range of pollutants, including heavy metals, chemicals, pathogens, and/or organic matter.

“Dilute hydrocarbon/organic matter sludge” is a liquid effluent with a hydrocarbon/organic matter containing solid, semisolid, suspended, dissolved, or slurry residual material. “Dilute hydrocarbon/organic matter sludge” may also contain mineral salts and metals, and it may be in the form of an emulsion. “Dilute hydrocarbon/organic matter sludge” is produced as a by-product of municipal, industrial, agricultural, or other processes. Typically, the hydrocarbon/organic matter or dry matter content of the dilute sludge in all forms can range from 0.1 up to 15 weight percent (wt %) in water.

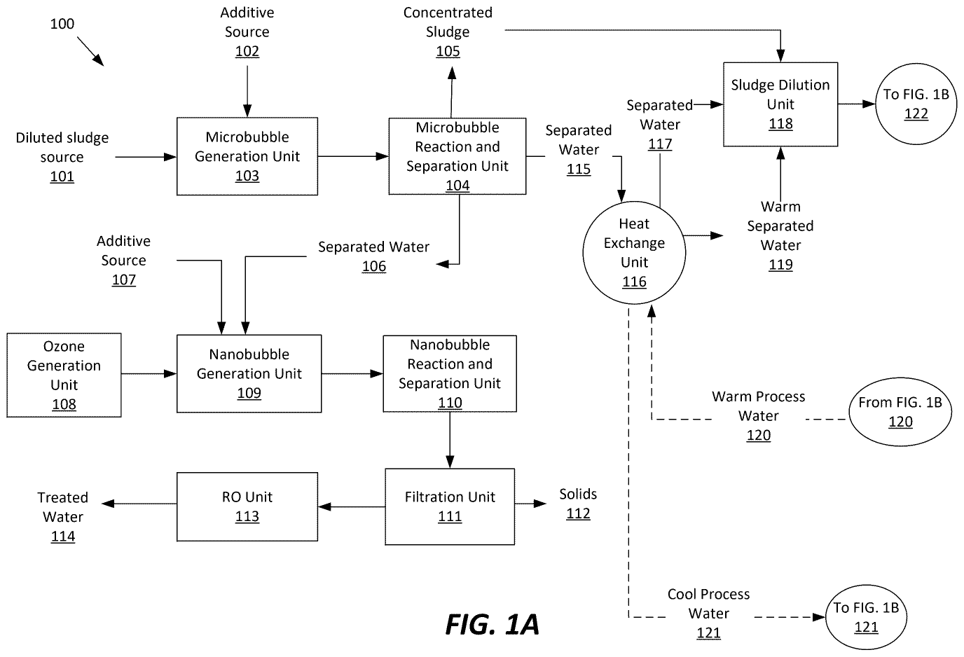

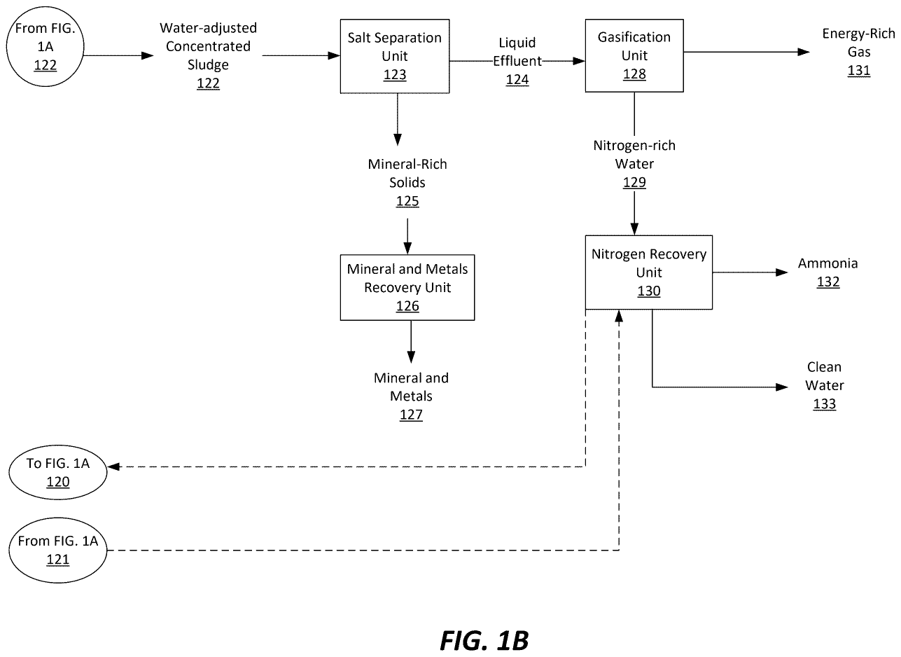

“Concentrated sludge” is dilute hydrocarbon/organic matter sludge which has been concentrated by removing some or most of its water content. Concentrated sludge may be an output of a microbubble reaction and separation process (FIG. 1A and FIG. 1B). The hydrocarbon/organic matter content of the concentrated sludge, in all its forms, can increase to up to 90 weight percent in water from the initial concentration of the dilute sludge. “Concentrated sludge” may also refer to a dilute hydrocarbon/organic matter sludge enriched with a hydrocarbon/organic matter material with a water content of up to 70 wt %.

“Water-adjusted concentrated sludge” is a concentrated sludge in which water has been added back to achieve a specific solid to liquid ratio. The added water may originate from a microbubble reaction and separation process (FIG. 1A and FIG. 1B) or from any other source. The specific solids to liquid ratio will depend on the requirements of the process in which the water-adjusted concentrated sludge is used as a feed source. Concentrated sludge or water-adjusted concentrated sludge will be used as a feed source to the salt separation process of hydrothermal gasification.

Typically, the hydrocarbon/organic matter content of the concentrated sludge or water-adjusted concentrated sludge, in all its forms, ranges from 10 to 60 weight percent in water. In various instances, the hydrocarbon and/or organic matter content may be 10 weight percent to 60 weight percent; 12 weight percent to 55 weight percent; 15 weight percent to 50 weight percent; 20 weight percent to 45 weight percent; 25 weight percent to 40 weight percent; or 30 weight percent to 35 weight percent in water. In various instances, the hydrocarbon and/or organic matter content may be no greater than 60 weight percent; no greater than 55 weight percent; no greater than 50 weight percent; no greater than 45 weight percent; no greater than 40 weight percent; or no greater than 35 weight percent in water. In various instances, the hydrocarbon and/or organic matter content may be no less than 10 weight percent; no less than 12 weight percent; no less than 15 weight percent; no less than 20 weight percent; no less than 25 weight percent; or no less than 30 weight percent in water.

### C. Exemplary Rare Earth Element (REE) Solutions

Rare earth element solution refers to a predominantly rare earth chloride or nitrate aqueous solution, such as lanthanum chloride or LaCl₃, cerium chloride or CeCl₃, as well as other rare earth element chloride solutions; and lanthanum nitrate or La(NO₃)₃, cerium nitrate, or Ce(NO₃)₃, as well as other rare earth element nitrate solutions. REE solutions are used to precipitate, co-precipitate, coagulate, flocculate, or otherwise remove contaminants. These solutions assist in generating treated water and/or promote the attachment of hydrocarbon/organic matter to the gas-water interface during microbubble reaction and separation (FIG. 1A and FIG. 1B). These solutions may also initiate or promote the degradation of the hydrocarbon/organic matter, but also the co-precipitation of inorganic elements.

Exemplary rare earth element solution concentrations range from about 2 percent to about 30 percent on a total rare earth oxide basis. In various instances, exemplary rare earth element solution concentrations may be 2 percent to 30 percent; 5 percent to 28 percent; 8 percent to 26 percent; 10 percent to 25 percent; 12 percent to 24 percent; 15 percent to 22 percent; or 18 percent to 20 percent on a total rare earth oxide basis. In various instances, exemplary rare earth element solution concentrations may be no greater than 30 percent; no greater than 28 percent; no greater than 26 percent; no greater than 25 percent; no greater than 24 percent; or no greater than 22 percent on a total rare earth oxide basis. In various instances, exemplary rare earth element solution concentrations may be no less than 2 percent; no less than 5 percent; no less than 8 percent; no less than 10 percent; no less than 12 percent; or no less than 15 percent on a total rare earth oxide basis.

Exemplary rare earth element solutions may be acidic with a pH value ranging between about 1.0 and about 4.0. In various instances, exemplary rare earth element solutions may have a pH value of 1.0 to 4.0; 1.5 to 3.8; 2.0 to 3.6; 2.2 to 3.5; 2.5 to 3.5; or 2.8 to 3.2. In various instances, exemplary rare earth element solutions may have a pH value of no greater than 4.0; no greater than 3.8; no greater than 3.6; no greater than 3.5; or no greater than 3.2. In various instances, exemplary rare earth element solutions may have a pH value of no less than 1.0; no less than 1.5; no less than 2.0; no less than 2.2; or no less than 2.5.

### D. Exemplary Additives

Additives refer predominantly to chemicals dosed to a specific stream or inventory. Additives may be dosed in a solid or solution form and may be used to achieve certain outcomes, for example, pH adjustment, viscosity adjustment, flocculation, coagulation, oxidation/reduction, precipitation, or complexation. Other outcomes may also be contemplated by those skilled in the art.

Exemplary additives may be dosed in a ratio of additive to stream (or inventory). The ratio of additive to stream or inventory can be lower than 10 percent. Exemplary additives can be organic or inorganic; acidic, neutral, or basic; as solid or solutions; concentrated (>10 percent by weight) or dilute (<10 percent by weight).

Rare earth element (REE) solutions, in the form of CeCl₃ or LaCl₃, for example, may catalyze or enhance the oxidation of the hydrocarbon/organic matter in the water, in the presence of ozone. The presence of ozone also maintains or recycles the cerium present in solution as in an active oxidized ceric form.

Depending on the application and nature of diluted sludge, pH adjustment by adequate addition of a relevant acid or base may be needed at various points in the process. In some instances, a pH adjustment material may comprise sodium hydroxide, lime (Ca(OH)₂), or hydrochloride. In some implementations, pH adjustment material is added in an amount to adjust the pH of the fluid to be an alkaline, neutral, or acidic pH. In some implementations, pH adjustment material is added in combination with a rare earth element (REE) solution.

### E. Exemplary Output Streams

“Liquid Effluent” is the output of the “salt separation” process of supercritical or subcritical hydrothermal gasification (FIG. 1A and FIG. 1B), in which inorganic salts, minerals, and metals have been recovered into a separate stream. “Liquid Effluent” is used as feed into the gasification unit of the supercritical hydrothermal gasification process (FIG. 1A and FIG. 1B).

“Water-adjusted concentrated sludge,” in all of its forms, typically, can have a water-adjusted concentration of hydrocarbon/organic matter from 3 up to 50 weight percent solids in water.

“Separated water” is a water stream that has been improved in water quality through a treatment method such as a microbubble and/or nanobubble process (FIG. 1A and FIG. 1B). These treatment processes remove contaminants and undesirable components from untreated water to make it suitable for specific uses or for free release into the environment. These treatment processes may also remove undesirable odors or coloration. Typical contaminant levels in “separated water” may have a COD value of <500 ppm and an oil-to-gas ratio of <10 ppm.

“Clean water” is a water stream that has been improved in water quality through a treatment method such as a nitrogen recovery unit (FIG. 1A and FIG. 1B). These treatment processes remove contaminants and undesirable components from untreated water to make it suitable for specific use or for free release into the environment.

“Ammonia” is a water stream in which ammonium hydroxide has been concentrated using a nitrogen recovery unit (FIG. 1A and FIG. 1B). Aqueous ammonia (or ammonium hydroxide) used as a fertilizer typically contains between 20% and 30% ammonia by weight.

“Solids” is a solid stream of oxidized solids generated in the nanobubble reaction and separation unit and separated from a water stream in the filtration unit. It may contain oxidized/precipitated solids, such as calcium (Ca) or sulfur(S) in all their forms, as well as other oxidized or precipitated solids.

“Mineral and Metals” is a solid stream generated under supercritical conditions and separated from a liquid effluent stream using a salt separation unit. The composition of the minerals and metals will depend on the initial composition of these elements and compounds in the dilute sludge source.

“Warm process water” is treated water that has been fed into a heat exchanger to capture any heat energy generated by any part of the overall combined and integrated process. “Warm process water” can have a temperature 10° C. higher than the initial temperature of the treated water, up to 95° C. if the water is at atmospheric pressure, or at 20° C. below the boiling point if the water is pressurized during its transport and before its use in the process. “Warm process water” may also be obtained via direct contact of process waters with steam (or other hot gases) through sparging or bubbling.

“Warm separated water” is a water separated from the concentrated sludge during the microbubbling process and heated by “warm process water” or any other hot or warm medium via heat exchange or by direct contact through sparging or bubbling. “Warm separated water” can have a temperature 10° C. higher than the initial temperature of the treated water, up to 95° C. if the water is at atmospheric pressure, or at a temperature 20° C. below the boiling point if the water is pressurized, during its transport, and before its use in the process. Typical contaminant levels in separated water may have a COD value of <5,000 ppm. Warm separated water is used to heat and adjust the water content of the concentrated sludge.

“Energy rich gas” is a vapor that is separated from the water, pressurized, and contains methane (CH₄) with the possible presence of hydrogen (H₂) and other light hydrocarbon/organic gases. The balance of “energy rich gas” is predominantly compressed carbon dioxide (CO₂) and saturated vaporized water. Energy rich gas is loaded in mechanical energy (i.e., pressure) and chemical energy (e.g., H₂ and CH₄). Energy rich gas is an output of hydrothermal gasification processes.

“Mineral rich solids” is an inorganic stream from the salt separation process of supercritical or subcritical hydrothermal gasification (FIG. 1A and FIG. 1B). This stream may comprise a variety of inorganic salts, minerals, dissolved metals, or co-precipitated salts in water. Some of the minerals and metals may have economic value. This stream may contain an organic phase that can be separated, recovered, and recycled back into either the diluted or concentrated sludge.

### F. Exemplary Enzymatic Materials

“Nanoenzymes” are artificial nanomaterials that mimic the properties of natural enzymes, and aid in the attachment of organic compounds to the gas-water interface of microbubbles in microbubble technology. Some examples of nanoenzymes include nanoparticles of ceric oxide (CeO₂), ceric phosphate (CePO₄), cobalt (II, III) oxide (CO₃O₄), cobalt ferrite (CoFe₂O₄), ferric oxide (Fe₂O₃), magnetite (Fe₃O₄), manganese selenide (MnSe). Other embodiments may include more or fewer enzymatic materials than described herein.

### III. Example Systems and Methods of Operation

Generally, exemplary systems and methods generate concentrated sludge and clean water streams from concentrating and water treating units installed upstream and integrated into a hydrothermal gasification unit. Such an arrangement prevents the carryover of unnecessary volumes of water into the hydrothermal gasification unit and allows the parallel and decoupled treatment of the excess water initially contained in the diluted sludge and separated from the resulting concentrated sludge, in volumes disproportionately larger than what the downstream hydrothermal gasification unit could manage in ways that would positively affect its operation and performance.

In exemplary systems and methods, the diluted sludge is first subjected to a microbubbling process, which operates analogous to a dissolved air flotation (DAF) unit. The microbubbling process has the ability to separate total suspended solids (TSS), COD, biological oxygen demand (BOD), fat, oil, and/or grease contained in the incoming diluted sludge, from the water. Air microbubbles lift organic-containing particles in the water.

The skimmed concentrated sludge may be pumped away downstream of the microbubble generation unit for further treatment/water adjustment before transferring to the hydrothermal gasification unit. Injection of suitable additives to the incoming diluted sludge lowers the viscosity of the generated highly concentrated sludge with dry matter greater than 10%, allowing its transfer via pumping by gravity or other means. The separated water is transferred to a downstream tank where it is subjected to ozonation through nanobubbling, resulting in a clean water stream.

In some implementations, oxidative degradation of hydrocarbons/organic matter is activated by rare earth compounds under water supercritical conditions. In some implementations, oxidative degradation results in the transformation of the hydrocarbons/organic matter into lower chain or simpler molecules by activation of the rare earth compounds in the presence of ozone. In some implementations, rare earth element solutions or additives function as coagulants and enhance the separation of the organic sludge from water in the microbubble and separation unit. In some implementations, injection of rare earth element solutions can promote the selective separation and recovery of salts and minerals from brines.

In applications with comparable feedstocks, the microbubbling step effectively separates hydrocarbon/organic matter from water, reducing the residual COD to below 200 ppm. Contact time between the microbubble and the liquid phase is the controlling parameter. The nanobubbling step reduces COD further below 50 ppm, through the oxidation and venting of the resulting gases (e.g., CO₂, VOCs). The ozone generation unit is sized to supply sufficient ozone to meet the minimum requirement of 1 mg of O₃ for 1 mg of COD removal.

A side-by-side comparison of a conventional DAF versus micro/nanobubbling treatment is illustrated in Table 1.

TABLE 1

| | Conventional | Micro/Nanobubble enabled |
|---|---|---|
| Parameter | DAF | DAF system |
| Suspended solid removal | 80-95% | 90-99% |
| from the incoming diluted | | |
| sludge | | |
| Oil and Grease removal | 70-90% | 85-98% |
| Energy Consumption | High | Low |
| Chemical Usage | Moderate | Low |
| Footprint | Large | Small |

The exact performance and cost savings may vary depending on the specific wastewater characteristics and technologies used to generate micro and nanobubbles. However, the overall trend suggests that Micro/Nanobubble enabled DAF systems are more efficient and cost-effective alternatives when compared to conventional DAF systems. In some embodiments, up to 99.9% removal of organic matter from water can be achieved.

Part of the separated water may be used to adjust the water content of the concentrated sludge and bring the concentrated sludge to a higher temperature using heat recovery. Additional additives may be injected to further tune the viscosity as required. Warm or cool process water generated downstream of the hydrothermal gasification unit may be used to produce a water-adjusted concentrated sludge stream and adjust its temperature. The clean water may be further polished to lower COD through filtration and/or reverse osmosis for specific applications and usages.

FIG. 1A and FIG. 1B show a schematic depiction of an exemplary system (100) for processing hydrocarbon/organic matter containing water streams into several output streams of economic value and clean water. As shown, the exemplary system (100) includes a microbubble generation unit (103), a microbubble reaction and separation unit (104), an ozone generation unit (108), a nanobubble generation unit (109), a nanobubble reaction and separation unit (110), a filtration unit (111), reverse osmosis (RO) unit (113), a heat exchange unit (116), a sludge dilution unit (118), salt separation unit (123), mineral and metals recovery unit (126), gasification unit (128), and nitrogen recovery unit (130). Other embodiments may include more or fewer units or components.

As shown in system (100), diluted sludge is first subjected to a microbubbling process (104) that separates total suspended solids (TSS), COD, biological oxygen demand (BOD), fat, oil, or grease contained in the incoming diluted sludge, from the water. Air microbubbles generated by microbubble generation unit (103) lift organic containing particles in the water.

The microbubble generation unit (103) is a device that is capable of producing micro-sized gas bubbles. In some instances, microbubbles may be generated by a DAF pump which dissolves air and generates microbubbles. The size of the microbubbles generated may vary between 800 nanometers (nm) and 100 micrometers (μm). In various instances, the microbubbles may have a size of 800 nm to 100 μm; 1 μm to 100 μm; 2 μm to 95 μm; 5 μm to 90 μm; 10 μm to 85 μm; 15 μm to 80 μm; 20 μm to 70 μm; 25 μm to 60 μm; or 30 μm to 50 μm. In various instances, the microbubbles may have a size of no greater than 100 μm, no greater than 95 μm, no greater than 90 μm, no greater than 85 μm, no greater than 80 μm, no greater than 70 μm, no greater than 60 μm, or no greater than 50 μm. In various instances, the microbubbles may have a size of no less than 800 nm, no less than 1 μm, no less than 2 μm, no less than 5 μm, no less than 10 μm, no less than 15 μm, no less than 20 μm, no less than 25 μm, or no less than 30 μm.

The microbubble generation unit (103) may generate microbubbles in various ways. In some instances, microbubbles are generated via compression of an air stream to dissolve air into liquid, which is subsequently released through a specially designed nozzle system, to nucleate small bubbles based on the cavitation principle. In some instances, microbubbles are generated via power ultrasound to induce cavitation locally at points of extreme rarefaction in the standing ultrasonic waves. In some instances, microbubbles are generated via an air stream delivered under low offset pressure, and air to break off the bubbles by mechanical vibration, flow focusing, or fluidic oscillation. Other technologies are contemplated to generate exemplary microbubbles.

The microbubble generation unit (103) is in fluid communication with a diluted sludge source (101) and additive source (102).

Exemplary additives provided by additive source (102) may comprise nanoenzymes, other suitable coagulants/flocculants, or a sludge viscosity reducer. Exemplary viscosity reducers enhance the fluidity and flowability of the resulting concentrated sludge.

Exemplary additives used as viscosity adjustment agents may be added to a stream or inventory in an amount of about 0.01 vol % to about 1 vol %, based on the volume of the base stream. In various instances, exemplary additives may be added in an amount of 0.01 vol % to 1 vol %; 0.01 vol % to 0.4 vol %; 0.01 vol % to 0.2 vol %; 0.01 vol % to 0.1 vol %; 0.01 vol % to 0.05 vol %; 0.013 vol % to 0.04 vol %; 0.02 vol % to 0.03 vol %; or 0.013 vol % to 0.02 vol %, relative to the base stream volume. In various instances, exemplary additives may be added in an amount of no greater than 0.01 vol %; no greater than 0.013 vol %; no greater than 0.02 vol %; no greater than 0.03 vol %; no greater than 0.04 vol %; no greater than 0.05 vol %; or no greater than 0.1 vol %, relative to the base stream volume. In various instances, exemplary additives may be added in an amount of no less than 1 vol %; no less than 0.4 vol %; no less than 0.2 vol %; no less than 0.1 vol %; no less than 0.05 vol %; no less than 0.04 vol %; or no less than 0.02 vol %, relative to the base stream volume.

Exemplary additives provided by additive source (102) may comprise pH adjustment material and/or rare earth element (REE) solution. The rate of addition of REE solution to treat the dilute sludge will be proportional to the salt content in the dilute sludge and elements targeted for precipitation, coprecipitation, coagulation, flocculation, or otherwise removed. The REE solution may be co-fed or added to the diluted sludge during the microbubble reaction and separation process (104). Typically, the ratio of total REE element (La, Ce, or other REE element) on a molar basis, over the targeted element to be removed on a molar basis, would range from about 0.5:1 to about 5:1. In various instances, the ratio may be 0.5:1 to 5:1; 0.75:1 to 4.5:1; 1:1 to 4:1; 1.25:1 to 3.5:1; 1.5:1 to 3:1; 2:1 to 2.75:1; or 2:1 to 2.5:1. In various instances, the ratio may be no greater than 5:1; no greater than 4.5:1; no greater than 4:1; no greater than 3.5:1; no greater than 3:1; or no greater than 2.5:1. In various instances, the ratio may be no less than 0.5:1; no less than 0.75:1; no less than 1:1; no less than 1.25:1; no less than 1.5:1; or no less than 2:1.

The microbubble reaction and separation unit (104) is in fluid communication with a microbubble generation unit (103) and receives a mixture of microbubbles, diluted sludge, and additives. The microbubble reaction and separation unit (104) uses microbubbles to generate separated water (106, 115) and concentrated sludge (105) output streams. Separated water (106) contains hydrocarbon/organic matter at levels which are above the regulatory limits that allow for free discharge of this water stream into the environment.

In some instances, the microbubble reaction and separation unit (104) may include (1) a flotation tank where the air microbubbles attach to the solids and other hydrocarbons and/or suspended organic matter and float them to the surface; (2) an air saturation system which includes a compressor, a saturation vessel, and pressure control valves to dissolve air as microbubbles into the recycle stream; and (3) a recycle pump which is used to pump the clarified effluent back to the saturation vessel; and a sludge removal system which skims the concentrated sludge from the surface of the tank.

The nanobubble generation unit (109) is in fluid communication with the microbubble reaction and separation unit (104), an additive source (107), and ozone generation unit (108). The nanobubble generation unit (109) receives a mixture of separated water (106), additives, and ozone.

Exemplary additives provided by additive source (107) may comprise nanoenzymes, other suitable coagulants/flocculants, or a sludge viscosity reducer. Exemplary additives provided by additive source (107) may comprise pH adjustment material and/or a rare earth element (REE) solution. In some instances, the REE solution may be co-fed or added to the separated water (106) resulting from the microbubble reaction and separation process (104). Without being bound by a particular theory, adding REE to the treated water may improve the overall efficiency of salt and mineral removal by complexation or co-precipitation, but also their selective recovery and separation thereof into individual streams, e.g., boron, arsenic, fluoride, phosphorus species, and other streams and minerals which have a natural affinity to rare earths.

An ozone generation unit (108) is a device that converts oxygen from various sources, such as ambient air, dry air, or concentrated oxygen. Ozone is a strong oxidant that can help degrade organic molecules and/or oxidize/precipitate mineral elements like calcium (Ca) and sulfur(S) into their solid forms.

Ozone generation unit (108) produces ozone (O₃) by adding energy to oxygen molecules (O₂), which causes the oxygen atoms to part ways and temporarily recombine with other oxygen molecules. One application of ozone is for water and air treatment or purification. Once ozone is produced, it reacts with a pollutant (of organic or inorganic nature), bacteria, virus, or mold, and breaks it down into less complex molecules through a process called oxidation. Ozone that has not reacted with other molecules will decompose into oxygen over time. Due to the instability of the ozone molecule, it has a short half-life. Therefore, ozone cannot be stored or transported and must be generated on-site. Depending on the specific application and/or limitations, ozone can be created from one of three sources: ambient air, dry air, or concentrated oxygen.

The nanobubble generation unit (109) is a device that is capable of producing nano-sized gas bubbles. Nanobubbles are gas vesicles (i.e., bubbles made from any gas). While nanobubbles naturally form in natural waters (e.g., crashing waves and waterfalls), they can also be created through advanced technology using a nanobubble generation unit (109). Unlike larger bubbles that quickly rise and pop due to buoyancy, nanobubbles remain suspended in liquids for a much longer time. Due to their size, Brownian motion is stronger than buoyancy, allowing them to stay in place and deliver oxygen, ozone (or other gases) precisely where it is needed.

Nanobubbles may be measured by their size, concentration, and charge. Air nanobubbles typically carry a charge between negative 15 and negative 30 millivolts. Their distinct size and structure unlock powerful capabilities, delivering transformative benefits across a range of applications. Nanobubbles optimize gas dissolution, enhance mixing, gas dispersion in solution, and accelerate/influence key physical, chemical, and biological processes, like oxidation and separation, making them an innovative solution for water treatment and other industrial applications. A defining property of nanobubbles is their ability to keep gas suspended in a liquid. Their high surface area and stability help retain gas much longer, making them ideal for oxygen transfer in water treatment applications.

Nanobubble generation unit (109) may generate nanobubbles in various ways. In some instances, nanobubbles are generated by compression of an ozone-containing gas, generally air or pure oxygen stream to dissolve the gas into the liquid, which is subsequently released through a specially designed nozzle system, to nucleate small bubbles as nanobubbles, based on the cavitation principle. In some instances, nanobubbles are generated by using power ultrasound to induce cavitation locally at points of extreme rarefaction in the standing ultrasonic waves. In some instances, nanobubbles are generated by using an air stream delivered under low offset pressure, and air to break off the bubbles by mechanical vibration, flow focusing, or fluidic oscillation. Other technologies are envisioned to generate nanobubbles by those skilled in the art.

A non-clogging diffuser device may enable higher efficiency and therefore reduced energy and O₃ consumption. Using a non-clogging diffuser device may remove 1 g of COD per 1 g of O₃ as opposed to 1 g of COD per 1.5 g of O₃ with conventional technology. As non-limiting examples, using normal air as a feedstock for the ozonation unit may generate 3% O₃ in air while using a 90% oxygen-enriched air feedstock may generate 13% O₃ air. As a non-limiting example, a gas dissolved rate of 94% may be achieved. As a non-limiting example, with this configuration, O₃ in pure distilled water is stable for 10-15 min, compared to conventional O₃ dispersers, where O₃ disappears within 1 to 2 minutes. A longer stability of ozone results in higher hydrocarbon/organic matter removal efficiency.

The size of the nanobubbles generated by nanobubble generation unit (109) may vary, and, in some instances, nanobubble sizes are in the range of 20 nanometers (nm) to 500 nm. In various instances, nanobubble sizes may be 20 nm to 500 nm; 30 nm to 450 nm; 40 nm to 400 nm; 50 nm to 350 nm; 75 nm to 300 nm; 100 nm to 250 nm; or 150 nm to 200 nm. In various instances, nanobubble sizes may be no greater than 500 nm; no greater than 450 nm; no greater than 400 nm; no greater than 350 nm; no greater than 300 nm; no greater than 250 nm; or no greater than 200 nm. In various instances, nanobubble sizes may be no less than 20 nm; no less than 30 nm; no less than 40 nm; no less than 50 nm; no less than 75 nm; no less than 100 nm; or no less than 150 nm.

As ozone-containing nanobubbles disperse in the separated water, the oxidative reaction of the organic and inorganic constituents contained in the water is accomplished by the reactivity of ozone; contact surface area between the ozone molecule and the organic and inorganic constituents; and the residence time between the ozone molecule and the organic and inorganic constituents. Organic material may be transformed by ozone into volatile organic compounds (VOCs). Dissolved inorganic material may be transformed by ozone into solids. The effect of the reaction of ozone with organic and inorganic constituents is a reduction in organic and inorganic content dissolved in the water.

In existing treatment processes, hydrocarbon/organic matter rich, concentrated sludge (105) is either disposed of in a landfill or incinerated. Depending on its composition, the resulting hydrocarbon/organic matter rich, concentrated sludge (105) using the exemplary process described herein, may be further processed or separated, using processes known to those skilled in the art into other valuable streams, to recover and/or recycle all or part of these valuable streams for other purposes. The separated water (106), which is essentially freed from its hydrocarbon/organic matter, metals, and salts, may be: sent for disposal, if the required specifications are met, recycled for various purposes, or further processed.

The split ratio of the separated water (106) used to concentrated sludge (105) and deviated to ozonation via nanobubble generation unit (109) may be between 0.0 to 1.0. In various instances, the split ratio of separated water (106) sent to nanobubble generation unit to concentrated sludge (105) may be 0.0 to 1.0; 0.1 to 0.9; 0.2 to 0.8; 0.25 to 0.75; 0.3 to 0.7; 0.4 to 0.6; or 0.45 to 0.55. In various instances, the split ratio may be no greater than 1.0; no greater than 0.9; no greater than 0.8; no greater than 0.75; no greater than 0.7; no greater than 0.6; or no greater than 0.5. In various instances, the split ratio may be no less than 0.0; no less than 0.1; no less than 0.2; no less than 0.25; no less than 0.3; no less than 0.4; or no less than 0.5.

The nanobubble reaction and separation unit (110) in fluid communication with a nanobubble generation unit (109) receives a mixture of separated water (106), additives (107), and a mixture of ozone-containing nanobubbles (1-15 wt. % ozone). The nanobubble reaction and separation unit (110) uses ozone-containing nanobubbles to enhance the reaction and separation. This process can be further enhanced with the use of coagulants or other additives (107). In some instances, a REE solution may be added during nanobubble and separation operations.

The filtration unit (111) is in fluid communication with a nanobubble reaction and separation unit (110). The filtration unit (111) separates water treated in the nanobubble reaction and separation unit (110) from solids and provides a solids (112) output stream. Solids (112) may include oxidized/precipitated mineral elements like Ca and S in their solid form.

The reverse osmosis (RO) unit (113) in fluid communication with the filtration unit (111) receives unpolished but treated water from the filtration unit (111). The RO unit (113) polishes the “untreated” water from the filtration unit (111) and generates a treated water (114) output stream. Treated water (114) contains hydrocarbon/organic matter or hydrocarbon/organic matter at levels that are below the regulatory limits that allow for free discharge of this water stream into the environment.

The heat exchange unit (116) is in fluid communication with a microbubble reaction and separation unit (104). The heat exchange unit (116) receives separated water (115), which is water that contains hydrocarbon/organic matter at levels that are above the regulatory limits that allow for free discharge of this water stream into the environment. Further, separated water (115) is a cold stream input at temperatures at or near ambient temperature.

In a closed loop configuration, the heat exchange unit (116) receives warm process water (120) from nitrogen recovery unit (130) downstream. After the exchange of heat between the warm process water (120) and separated water (115) in the heat exchange unit (116), cool process water (121) is sent back to the nitrogen recovery unit (130), and an output stream of warm process water (119) is generated from the heat exchange unit (116). Heat integration via the heat exchange unit (116) may improve energy and cost efficiencies by heating up separated water (115) to produce warm process water (119). Warm process water (119) can then be used to tune the physical (e.g., viscosity and density) and chemical characteristics of the concentrated sludge (105) in sludge dilution unit (118).

In some implementations, the heat exchange unit (116) is partially or fully bypassed. In those implementations, bypassed separated water (117) from the microbubble and separation unit (104) may be provided to sludge dilution unit (118) rather than warm process water (119) from the heat exchange unit (116).

The sludge dilution unit (118) in fluid communication with the microbubble reaction and separation unit (104) receives a concentrated sludge (105) stream. In some configurations, the sludge dilution unit (118) in fluid communication with the heat exchange unit (116) receives warm process water (119). In other configurations, the sludge dilution unit (118) in fluid communication with the microbubble reaction and separation unit (104) receives separated water (117) stream. The two water streams, separated water (117) or warm process water (119), are used to dilute the concentrated sludge (105) in the sludge dilution unit (118) to produce a water-adjusted concentrated sludge (122). Injecting separated water (117) or warm process water (119) into the concentrated sludge (105) enables tuning of the sludge composition for desired hydrocarbon/organic matter content and/or physical properties in the water-adjusted concentrated sludge (122).

For instance, combining separated water (117) or warm process water (119) with concentrated sludge (105) improves the transferability and compressibility of the concentrated sludge (105), or tunes the hydrocarbon/organic matter to water ratio of the concentrated sludge (105) for downstream processing. Dilution of the concentrated sludge (105) may maximize recovery of organic matter, salts, metals, and minerals from the separated water (117). Dilution of the concentrated sludge (105) may enable optimized performance at the salt separation unit (123) and mineral and metals recovery unit (126).

The ability to tune the water to hydrocarbon/organic matter ratio in the water-adjusted concentrated sludge (122) allows for a wider range of dilute sludge streams to be considered from various industrial sources. Furthermore, separated water (117) can be used to fluidize concentrated sludge (105) generated from different sources and processes, e.g., anaerobic and aerobic biological digestion. In some implementations, additives may be used and added at various stages of this process to reduce the viscosity of the concentrated sludge (105) or water-adjusted concentrated sludge (122). In some instances, REE solution may be added to the water-adjusted concentrated sludge (122).

The salt separation unit (123) in fluid communication with the sludge dilution unit (118) receives a water-adjusted concentrated sludge (122). The water-adjusted concentrated sludge (122) is raised to supercritical or subcritical conditions in the salt separation unit (123). Supercritical or subcritical conditions may be achieved at any convenient location upstream of the salt separation unit (123).

In some embodiments, the salt separation unit (123) may be fed with a mixture of diluted sludge and material highly concentrated in organic/hydrocarbon content (>20% dry matter content). An example of such material would be decanter cake generated in palm oil mills.

“Supercritical condition” refers to a state where a substance, such as water, is above its critical temperature and pressure (22.12 MPa and 372.12° C.) leading to unique properties like a single homogeneous fluid phase with characteristics between a gas and a liquid. Supercritical water is a poor solvent for electrolytes such as salts, but an excellent solvent for nonpolar molecules, such as hydrocarbon/organic matter.

Exemplary unit operations (100) described herein may be operated at subcritical conditions, where the feeds are maintained at temperatures between 100° C. and 374.15° C. and at pressures high enough (typically 0.1 to 22.1 MPa) to maintain the water in the liquid state. This condition is called “pressurized hot water” or “superheated water”. Under these subcritical conditions, water remains a liquid but exhibits significantly different physical and chemical properties than at ambient conditions, allowing it to function as a solvent for organic compound extraction, salts separation, and chemical reactions.

The salt separation unit (123) separates organic and inorganic components into separate streams under supercritical or subcritical water conditions. The inorganic components are collected as mineral-rich solids (125), which contain dissolved salts in the form of an aqueous brine, and contain low levels of hydrocarbon/organic matter. The organic components are collected as a liquid effluent (124) which is in the form of an aqueous solution containing hydrocarbon/organic matter that can be recycled back into the process in the appropriate location before the salt separation unit to maximize hydrocarbon/organic matter recovery and its ultimate gasification in the gasification unit (128).

The gasification unit (128) in fluid communication with the salt separation unit (123) receives liquid effluent (124). The liquid effluent (124) is particularly suited for use in hydrothermal gasification operations for various reasons. The liquid effluent (124) has a lower chance of corrosion, clogging, or blocking of equipment used in gasification unit (128) because of the lower salt, mineral, and metal content. The liquid effluent (124) has a lower chance of catalyst poisoning because of the removal or reduction of various contaminants initially present in the concentrated sludge, such as sulfur and other elements.

The gasification unit (128) generates energy-rich gas (131) and nitrogen-rich water (129) as output streams. The gasification unit (128) includes treating wet or water-miscible hydrocarbon/organic matter effluents (e.g., municipal sludge, agricultural and food residues, agricultural and industrial effluents, etc.) with or without a catalyst. This thermochemical conversion process is used to transform hydrocarbon/organic matter into energy-rich gas (131) which contains elevated levels of methane, some hydrogen, and CO₂. Energy-rich gas (131) may comprise methane (CH₄), hydrogen (H₂), and carbon dioxide (CO₂). Energy-rich gas (131) may be essentially free of NOₓ and SOₓ.

Supercritical or Subcritical Water Separation (SCWS) process in the gasification unit (128) separates hydrocarbon/organic matter containing streams into organic and inorganic components. For water, supercritical conditions can be achieved at or above 22.12 MPa and 372.12° C. Organic components can be transformed into hydrogen (H₂), methane (CH₄), and carbon dioxide (CO₂), predominantly, by a catalytic or non-catalytic hydrothermal gasification (HTG) unit. The hydrothermal gasification technology can be used to treat and process hydrocarbon/organic matter containing water streams as feedstocks to generate, under supercritical conditions, several valuable streams. Examples of these streams include concentrated salt waters (i.e., brines of salts, minerals, and metals), dilute salts in process water, primary energy in the form of pressurized methane (and potentially hydrogen) and heat, pressurized carbon dioxide, and clean treated water. The calorific gas (CH₄/H₂) components can be ultimately converted into heat and power using a combined heat and power system (CHP), distributed as compressed gas, or used as feedstocks for other purposes. Depending on the input stream, inorganic components can be valorized into fertilizers. FIG. 1B illustrates one possible configuration of the Supercritical or subcritical Hydrothermal Gasification (SCHG) (i.e., HTG combined with SCWS) technology.

The gasification unit (128) may provide nitrogen-rich water (129) to a nitrogen recovery unit (130). Nitrogen recovery unit (130) utilizes nitrogen-rich water (129) generated in the gasification unit (128) and converts this stream into an ammonia (132) stream.

The nitrogen recovery unit (130) in fluid communication with the gasification unit (128) receives nitrogen-rich water (129). The nitrogen recovery unit (130) separates an ammonia (132) stream from clean water (133). Clean water (133) generated by the nitrogen recovery unit (130) may have a chemical oxygen demand (COD) value of less than 250 ppm and an oil to gas ratio of less than 5 ppm. In some instances, the ammonia (132) stream may be used as fertilizer in agricultural applications.

Heat from the nitrogen recovery unit (130) is captured as warm, clean water (133). A portion of warm, clean water (133), warm process water (120), may be in fluid communication with the heat exchange unit (116). Warm process water (120) exchanges heat with separated water (115) in the heat exchange unit (116) and is then sent back to the nitrogen recovery unit (130) in a closed loop. In some implementations, warm, clean water (133) from the nitrogen recovery unit (130) may be used to regenerate the hydrothermal gasification catalyst in the gasification unit (128).

Mineral and metals recovery unit (126) in fluid communication with the salt separation unit (123) receives mineral-rich solids (125). Mineral and metals recovery unit (126) generates a mineral and metals stream (127) which may comprise a variety of inorganic salts, minerals, dissolved metals, or co-precipitated salts in water. Some of the minerals and metals may have economic value.

In some implementations, warm process water (120) from the nitrogen recovery unit (130) may be used to flush or clean equipment, instruments, or other components of the microbubble reaction and separation unit (110).

In some implementations, the separated water (115) from the microbubble reaction and separation unit (104) may be used to flush or clean equipment, instruments, or other components of the gasification unit (128). In these implementations, resulting hydrocarbon/organic matter containing streams from regeneration, cleaning, or flushing activities (via the recycling of these streams either in-situ or ex-situ) may be further processed to remove their hydrocarbon/organic matter contents. Thereby, novel wastewater streams from the gasification unit (128) are minimized or eliminated, and a net amount of clean water (133) is optimized.

It is understood that the foregoing detailed description and accompanying examples are merely illustrative and are not to be taken as limitations upon the scope of the disclosure. Various changes and modifications to the disclosed embodiments will be apparent to those skilled in the art. Such changes and modifications, including without limitation those relating to the chemical structures, substituents, derivatives, intermediates, syntheses, compositions, formulations, pH and temperature adjustments, separation, recovery, or methods of use, may be made without departing from the spirit and scope of the disclosure.

### IV. Experimental Examples

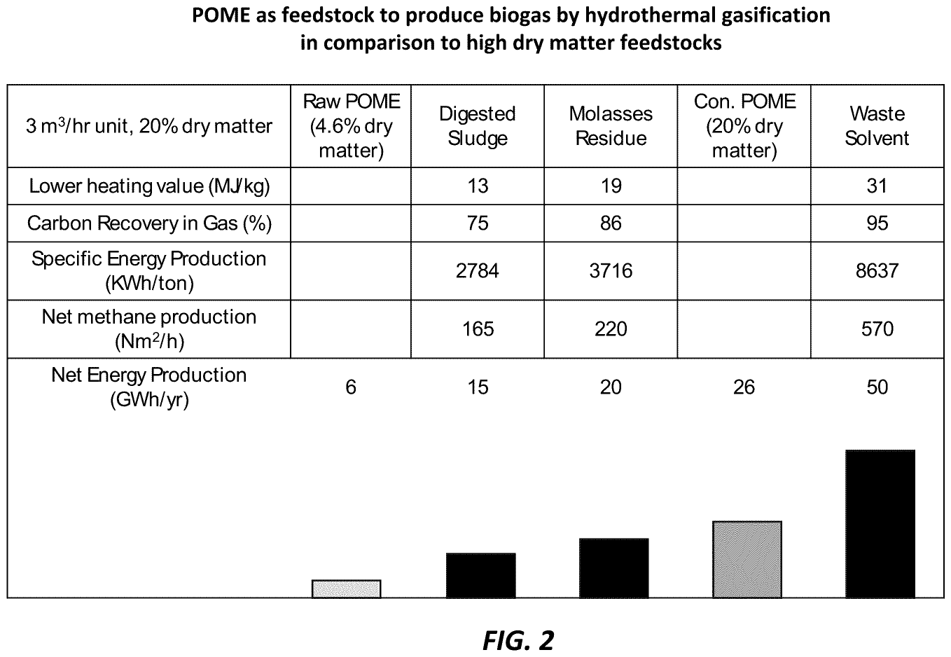

A hydrothermal gasification unit operating under supercritical conditions processes around 3 m³/h of waters rich in hydrocarbon/organic matters (i.e., diluted sludges). FIG. 2 shows results illustrating the amount of energy produced from raw POME via the hydrothermal gasification process under supercritical conditions. The yield obtained for raw POME is low compared to organic-rich water feedstocks (e.g., digested sludges, molasses, or waste solvents, all with high dry matter). In FIG. 2, a hydrothermal gasification test was conducted over a period of 4-6 hrs. The organic feed material was mixed in a stirred tank and then fed through a high-pressure pump with a flow rate between 0.4 to 0.8 kg/hr at 250 bar. The pressurized water stream was heated to ~450° C. to supercritical conditions and then passed through a salt separator also at ~450° C., where the solid mineral salts were separated and removed from the supercritical water solution (SCWS). The SCWS was then fed into a catalytic hydrothermal gasification reactor with a Rh-doped catalyst operating at ~350° C. and 250 bar, where the catalytic digestion of the organic component was affected. The output stream from the reactor passed through a liquid/gas separator, at pressure, separating the water phase from the pressurized gas stream. The gas stream composition was then analyzed by micro GC analysis to determine the composition and energy content.

A prophetic example arrangement for a palm oil mill generating 800 m³/d of POME (4% wt. DM) would require three concentrating and water treatment units, each with approximately 300 m³/h capacity, generating a total amount of up to 160 m³/d of concentrated sludge (20% wt. DM). This prophetic configuration includes two hydrothermal gasification reactors of individual capacities of 80 m³/d, resulting in 640 m³/d of clean water generated from the upstream concentrating and water treatment unit. In comparison, the traditional configuration of hydrothermal gasification would require up to 10 reactors to treat 800 m³/d of POME (4% DM) because of the excessive amount of water carried through as dead volume.

### Embodiments

For reasons of completeness, the following Embodiments are provided.

Embodiment 1. A system for processing hydrocarbon and/or organic matter containing water streams, the system comprising: a microbubble generation unit in fluid communication with a diluted sludge source, the diluted sludge source comprising hydrocarbon and/or organic matter; a microbubble reaction and separation unit in fluid communication with the microbubble generation unit; an ozone generation unit; a nanobubble generation unit in fluid communication with the ozone generation unit; a nanobubble reaction and separation unit in fluid communication with the nanobubble generation unit; a heat exchange unit in fluid communication with the microbubble reaction and separation unit; a sludge dilution unit in fluid communication with the heat exchange unit; a salt separation unit in fluid communication with the sludge dilution unit; a gasification unit in fluid communication with the salt separation unit; and a nitrogen recovery unit in fluid communication with the gasification unit.
Embodiment 2. The system according to Embodiment 1, wherein the microbubble reaction and separation unit generates a separated water output and a concentrated sludge output; wherein using the separated water output from the microbubble reaction and separation unit, the nanobubble reaction and separation unit generates treated water as an output, the treated water having lower chemical oxygen demand, salt, and mineral content than the separated water output; wherein the sludge dilution unit receives separated water generated by the microbubble reaction and separation unit; and wherein the sludge dilution unit generates water-adjusted concentrated sludge by combining the separated water with the concentrated sludge output from the microbubble reaction and separation unit.
Embodiment 3. The system according to Embodiment 1 or Embodiment 2, wherein the salt separation unit receives water-adjusted concentrated sludge from the sludge dilution unit; wherein the salt separation unit separates organic material in the water-adjusted concentrated sludge from inorganic material containing metals, minerals, and co-precipitated salts in the water-adjusted concentrated sludge, the organic material being an enhanced treated feedstock; and wherein the enhanced treated feedstock is provided to the gasification unit for supercritical hydrothermal gasification treatment.
Embodiment 4. The system, according to any one of Embodiments 1-3, further comprising one or more rare earth element solution and additive injection locations, wherein rare earth element solutions or additives are injected at the microbubble and separation unit, or at the microbubble generation unit, and wherein the rare earth element solution is at a concentration ranging from 2% to 30% total rare earth oxide (TREO).
Embodiment 5. The system, according to any one of Embodiments 1-4, further comprising one or more viscosity reducer injection locations.
Embodiment 6. The system according to Embodiment 5, the one or more viscosity reducer injection locations being at least one of: at the microbubble generation unit, at the nanobubble generation unit, and into an output stream from the sludge dilution unit.
Embodiment 7. The system according to any one of Embodiments 1-6, further comprising: a filtration unit in fluid communication with the nanobubble reaction and separation unit; and a reverse osmosis unit in fluid communication with the filtration unit.
Embodiment 8. The system according to Embodiment 7, further comprising: a mineral and metals recovery unit in fluid communication with the salt separation unit; and a nitrogen recovery unit in fluid communication with the gasification unit.
Embodiment 9. The system according to Embodiment 8, wherein a warm process water stream from the nitrogen recovery unit is in fluid communication with the heat exchange unit.
Embodiment 10. The system according to Embodiment 9, wherein a cool process water stream from the heat exchange unit is in fluid communication with the nitrogen recovery unit.
Embodiment 11. A method for processing a hydrocarbon- and/or organic-matter-containing water stream, the method comprising: introducing a diluted sludge comprising hydrocarbon and/or organic matter into a microbubble generation unit; generating microbubbles and contacting the diluted sludge with the microbubbles in a microbubble reaction and separation unit; separating, in the microbubble reaction and separation unit, the diluted sludge into a separated water stream and a concentrated sludge stream; providing a portion of the separated water stream to a heat-exchange unit; adjusting the concentrated sludge by combining the concentrated sludge stream with at least a portion of the separated water stream to form a water-adjusted concentrated sludge; separating salts and inorganic material from the water-adjusted concentrated sludge to form an enhanced treated feedstock; gasifying the enhanced treated feedstock in a gasification unit; recovering nitrogen from products of the gasification unit; directing at least a portion of the separated water stream to a nanobubble generation unit; generating ozone and providing the ozone into a nanobubble generation unit; generating nanobubbles and contacting the separated water stream with the nanobubbles in a nanobubble reaction and separation unit; and producing treated water having reduced chemical oxygen demand, salt content, and mineral content relative to the separated water stream.
Embodiment 12. The method according to Embodiment 11, wherein separating salts and inorganic material from the water-adjusted concentrated sludge comprises: separating organic material from inorganic material comprising metals, minerals, and co-precipitated salts; and providing organic material as the enhanced treated feedstock to a supercritical hydrothermal gasification process.
Embodiment 13. The method according to Embodiment 11 or Embodiment 12, further comprising injecting a rare earth element solution or additive at one or more locations selected from the microbubble generation unit and the microbubble reaction and separation unit, wherein the rare earth element solution functions as a coagulant to enhance separation of organic sludge from water.
Embodiment 14. The method according to Embodiment 13, wherein injecting the rare earth element solution further promotes selective separation and recovery of salts and minerals from brines; wherein the rare earth element solution has a concentration of from 2% to 30% total rare earth oxide (TREO); and where a ratio of total REE element on a molar basis, over a targeted element to be removed on a molar basis, is from 0.5:1 to 5:1.
Embodiment 15. The method according to any one of Embodiments 11-14, further comprising injecting a viscosity reducer into at least one of the concentrated sludge stream or the water-adjusted concentrated sludge, wherein the viscosity reducer enhances fluidity and flowability of the concentrated sludge during downstream processing.
Embodiment 16. The method according to Embodiment 15, wherein the viscosity reducer is injected in an amount of 0.01 vol % to 1 vol %, based on a volume of the concentrated sludge stream or the water-adjusted concentrated sludge.
Embodiment 17. The method according to any one of Embodiments 11-16, wherein a size of the microbubbles generated is between 800 nanometers (nm) and 100 micrometers (μm); and wherein a size of the nanobubbles generated is between 20 nanometers (nm) to 500 nm.
Embodiment 18. The method according to Embodiment 17, wherein oxidative degradation of hydrocarbons and/or organic matter is activated by rare earth compounds under supercritical water conditions, and wherein the oxidative degradation transforms the hydrocarbons and/or organic matter into lower-chain or simpler molecules.
Embodiment 19. The method according to any one of Embodiments 11-18, further comprising: directing a warm process water stream recovered during nitrogen recovery to the heat-exchange unit to transfer thermal energy to at least a portion of the separated water stream; and returning a cooled process water stream from the heat-exchange unit to the nitrogen recovery unit.
Embodiment 20. The method according to any one of Embodiments 11-19, further comprising: filtering the treated water produced by the nanobubble reaction and separation unit to remove suspended solids; and subjecting the filtered treated water to reverse osmosis to further reduce dissolved salts and minerals.

1. A system for processing hydrocarbon and/or organic matter containing water streams, the system comprising:
a microbubble generation unit in fluid communication with a diluted sludge source, the diluted sludge source comprising hydrocarbon and/or organic matter;
a microbubble reaction and separation unit in fluid communication with the microbubble generation unit;
an ozone generation unit;
a nanobubble generation unit in fluid communication with the ozone generation unit;
a nanobubble reaction and separation unit in fluid communication with the nanobubble generation unit;
a heat exchange unit in fluid communication with the microbubble reaction and separation unit;
a sludge dilution unit in fluid communication with the heat exchange unit;
a salt separation unit in fluid communication with the sludge dilution unit;
a gasification unit in fluid communication with the salt separation unit; and
a nitrogen recovery unit in fluid communication with the gasification unit.

2. The system according to claim 1, wherein the microbubble reaction and separation unit generates a separated water output and a concentrated sludge output;
wherein using the separated water output from the microbubble reaction and separation unit, the nanobubble reaction and separation unit generates treated water as an output, the treated water having lower chemical oxygen demand, salt, and mineral content than the separated water output;
wherein the sludge dilution unit receives separated water generated by the microbubble reaction and separation unit; and
wherein the sludge dilution unit generates water-adjusted concentrated sludge by combining the separated water with the concentrated sludge output from the microbubble reaction and separation unit.

3. The system according to claim 1, wherein the salt separation unit receives water-adjusted concentrated sludge from the sludge dilution unit;
wherein the salt separation unit separates organic material in the water-adjusted concentrated sludge from inorganic material containing metals, minerals, and co-precipitated salts in the water-adjusted concentrated sludge, the organic material being an enhanced treated feedstock; and
wherein the enhanced treated feedstock is provided to the gasification unit for supercritical hydrothermal gasification treatment.

4. The system, according to claim 1, further comprising one or more rare earth element solution and additive injection locations,
wherein rare earth element solutions or additives are injected at the microbubble and separation unit, or at the microbubble generation unit, and
wherein the rare earth element solution is at a concentration ranging from 2% to 30% total rare earth oxide (TREO).

5. The system, according to claim 1, further comprising one or more viscosity reducer injection locations.

6. The system according to claim 5, the one or more viscosity reducer injection locations being at least one of: at the microbubble generation unit, at the nanobubble generation unit, and into an output stream from the sludge dilution unit.

7. The system according to claim 1, further comprising:
a filtration unit in fluid communication with the nanobubble reaction and separation unit; and
a reverse osmosis unit in fluid communication with the filtration unit.

8. The system according to claim 7, further comprising:
a mineral and metals recovery unit in fluid communication with the salt separation unit; and
a nitrogen recovery unit in fluid communication with the gasification unit.

9. The system according to claim 8, wherein a warm process water stream from the nitrogen recovery unit is in fluid communication with the heat exchange unit.

10. The system according to claim 9, wherein a cool process water stream from the heat exchange unit is in fluid communication with the nitrogen recovery unit.

11. A method for processing a hydrocarbon- and/or organic-matter-containing water stream, the method comprising:
introducing a diluted sludge comprising hydrocarbon and/or organic matter into a microbubble generation unit;
generating microbubbles and contacting the diluted sludge with the microbubbles in a microbubble reaction and separation unit;
separating, in the microbubble reaction and separation unit, the diluted sludge into a separated water stream and a concentrated sludge stream;
providing a portion of the separated water stream to a heat-exchange unit;
adjusting the concentrated sludge by combining the concentrated sludge stream with at least a portion of the separated water stream to form a water-adjusted concentrated sludge;
separating salts and inorganic material from the water-adjusted concentrated sludge to form an enhanced treated feedstock;
gasifying the enhanced treated feedstock in a gasification unit;
recovering nitrogen from products of the gasification unit;
directing at least a portion of the separated water stream to a nanobubble generation unit;
generating ozone and providing the ozone into a nanobubble generation unit;
generating nanobubbles and contacting the separated water stream with the nanobubbles in a nanobubble reaction and separation unit; and
producing treated water having reduced chemical oxygen demand, salt content, and mineral content relative to the separated water stream.

12. The method according to claim 11, wherein separating salts and inorganic material from the water-adjusted concentrated sludge comprises:
separating organic material from inorganic material comprising metals, minerals, and co-precipitated salts; and
providing organic material as the enhanced treated feedstock to a supercritical hydrothermal gasification process.

13. The method according to claim 11, further comprising injecting a rare earth element solution or additive at one or more locations selected from the microbubble generation unit and the microbubble reaction and separation unit,
wherein the rare earth element solution functions as a coagulant to enhance separation of organic sludge from water.

14. The method according to claim 13, wherein injecting the rare earth element solution further promotes selective separation and recovery of salts and minerals from brines;
wherein the rare earth element solution has a concentration of from 2% to 30% total rare earth oxide (TREO); and
where a ratio of total REE element on a molar basis, over a targeted element to be removed on a molar basis, is from 0.5:1 to 5:1.

15. The method according to claim 11, further comprising injecting a viscosity reducer into at least one of the concentrated sludge stream or the water-adjusted concentrated sludge,
wherein the viscosity reducer enhances fluidity and flowability of the concentrated sludge during downstream processing.

16. The method according to claim 15, wherein the viscosity reducer is injected in an amount of 0.01 vol % to 1 vol %, based on a volume of the concentrated sludge stream or the water-adjusted concentrated sludge.

17. The method according to claim 11, wherein a size of the microbubbles generated is between 800 nanometers (nm) and 100 micrometers (μm); and
wherein a size of the nanobubbles generated is between 20 nanometers (nm) to 500 nm.

18. The method according to claim 17, wherein oxidative degradation of hydrocarbons and/or organic matter is activated by rare earth compounds under supercritical water conditions, and
wherein the oxidative degradation transforms the hydrocarbons and/or organic matter into lower-chain or simpler molecules.

19. The method according to claim 11, further comprising:
directing a warm process water stream recovered during nitrogen recovery to the heat-exchange unit to transfer thermal energy to at least a portion of the separated water stream; and
returning a cooled process water stream from the heat-exchange unit to the nitrogen recovery unit.

20. The method according to claim 11, further comprising:
filtering the treated water produced by the nanobubble reaction and separation unit to remove suspended solids; and
subjecting the filtered treated water to reverse osmosis to further reduce dissolved salts and minerals.
